(19) United States
(12) Patent Application Publication
(10) Pub. No.: US 2013/0080076 A1
(43) Pub. Date: Mar. 28, 2013

(54) EXAMINATION SYSTEM FOR CRYSTALLINE SILICON SOLAR CELL

(71) Applicants: FU-WEN CHEN, New Taipei City (TW); Wen-Sheng Hsiao, New Taipei City (TW)

(72) Inventors: FU-WEN CHEN, New Taipei City (TW); Wen-Sheng Hsiao, New Taipei City (TW)

(21) Appl. No.: 13/241,289

(22) Filed: Sep. 23, 2011

(51) Int. Cl. G06F 19/00

(52) U.S. Cl. 702/39

(57) ABSTRACT

The examination system contains a vibration device, a signal generation device, an audio collection device, and a processing device. A crystalline silicon solar cell is placed on the vibration device. The signal generation device drives the vibration device to vibrate and the crystalline silicon solar cell is synchronously vibrated at a high speed. The audio collection device collects sound from the vibration and the processing device analyzes the sound to determine if the crystalline silicon solar cell has internal cracks or not.

### TECHNICAL FIELD OF THE INVENTION

The present invention is generally related to crystalline silicon solar cells, and more particular to an examination system for quickly identifying whether a crystalline silicon solar cell has surface or internal cracks or not.

### DESCRIPTION OF THE PRIOR ART

Currently, solar cells made from crystalline silicon are most mature in terms of technology. Even though solar cells made from monocrystalline silicon have better efficiency than those made from polycrystalline silicon, the latter requires a production process of less difficulty and lower cost. When recycling defective cells, the latter also enjoys a process of relatively lower cost. As such, polycrystalline silicon has become the mainstream material for solar cells. However, the surface or internal crack has been a major problem to the production of polycrystalline-silicon solar cells. Existing examination or inspection mechanisms for the surface or internal crack include Electroluminescence (EL) and photoluminescence (PL) imaging, both requiring human involvement. The PL imaging is mainly adopted by the upstream wafer manufacturers for sampling testing due to its requirements on the work pieces' surfaces and the remove of excessive material that would cause interference, in addition to its time consuming process. Furthermore, since the etched pattern and the material for printing would produce a spectrum interfering with that of the solar cell, the resulted PL image would be hard to decipher. On the other hand, the EL image to a polycrystalline-silicon solar cell usually contains numerous stripes or shadows, which are not necessarily related to any cracks of the solar cell but simply due to the inconsistency of the lattice arrangement. To avoid misjudgment, an experienced examiner or inspector is required and some further testing by applying electricity on the solar cell is performed. This is not only time consuming but also may cause accident damage to the solar cell. Therefore, EL imaging is also mainly used for sample testing. EL imaging cannot achieve accuracy more than 30% .

Due to the fierce market competition in recent days, wafer manufacturers only perform examination to a limited set of samples for cost reduction. This significantly increases the risk of the downstream manufacturers.

### SUMMARY OF THE INVENTION

A major objective of the present invention is to provide an examination system for identifying if crystalline silicon solar cells have surface or internal cracks and distinguishing those with defects from those without defects quickly and effectively so as to reduce potent damage by manual inspecting, to increase production yields, and to achieve high quality production by automated quality control.

The examination system contains a vibration device with at least a support element for the placement of a crystalline silicon solar cell. A signal generation device controls the vibration device to vibrate. An audio collection device is placed adjacent to the vibration device and collects the sound from the vibrated crystalline silicon solar cell. A processing device processes the sound collected by the audio collection device and shows the analysis result on a display. If the crystalline silicon solar cell does have any surface or internal crack, there would be high-frequency noise from the friction of the lattice of the crystalline silicon solar cell. The high-frequency frictional noise is collected by the audio collection device and delivered to the processing device for analysis. Then a spike will be shown on the display. If the crystalline silicon solar cell does not have any surface or internal crack, there would be no high-frequency frictional noise from the vibrated crystalline silicon solar cell and therefore no spike is shown on the display. In contrast to the prior art, the present invention does not required experienced staff and avoids misjudgment of manual inspection due to the interference from the internal cracks and external etched layer in PL imaging, or due to the various stripes and shadows from the heterogeneous lattice arrangement of crystalline silicon solar cells in EL imaging.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing an examination system according to an embodiment of the present invention.

FIG. 2 is a functional block diagram of the examination system of FIG. 1.

FIG. 3 is a schematic diagram showing an operation scenario of the examination system of FIG. 1.

FIG. 4 is a schematic diagram showing another operation scenario of the examination system of FIG. 1.

FIG. 5 is a schematic diagram showing an examination system according to another embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

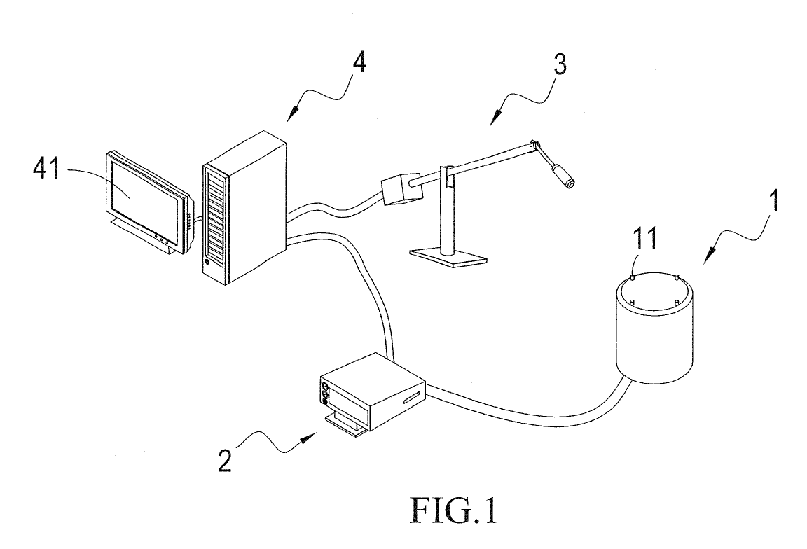

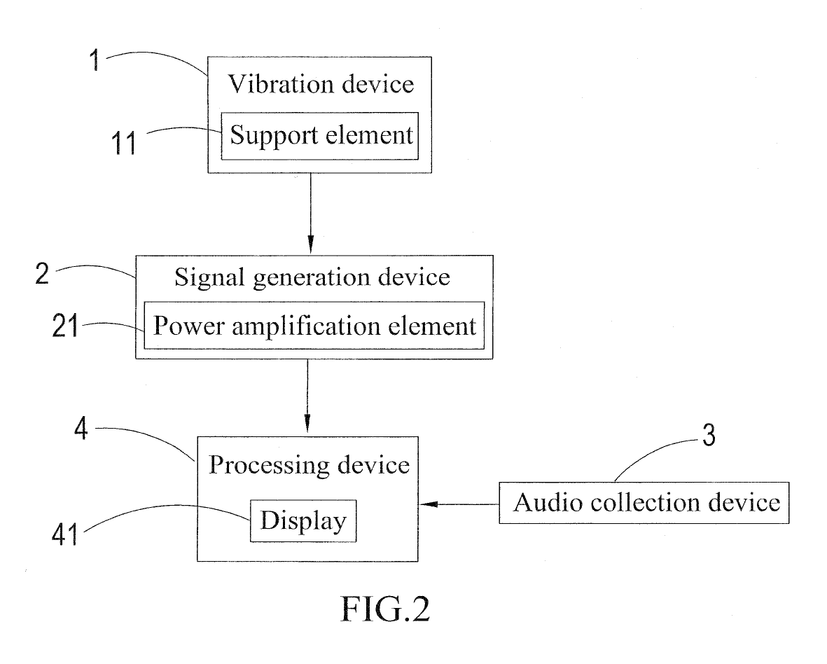

As shown in FIGS. 1 and 2, an examination system for crystalline silicon solar cells according to an embodiment of the present invention contains the following components.

A vibration device 1 contains at least a support element 11 for the placement of a crystalline silicon solar cell. The vibration device 1 is one of an electromagnetic vibration device, a mechanical vibration device, a supersonic vibration device, and an air stroke vibration device (an electromagnetic vibration device is used in the present embodiment).

A signal generation device 2 controls the vibration device 1 to vibrate the support element 11. The signal generation device 2 contains a power amplification element 21.

An audio collection device 3 such as a microphone is placed adjacent to the vibration device 1 and collects the sound from the vibrated crystalline silicon solar cell.

A processing device 4 such as a computer is connected to a display 41. The processing device 4 is also connected to the signal generation device 2 and the audio collection device 3, and processes the sound collected by the audio collection device 3.

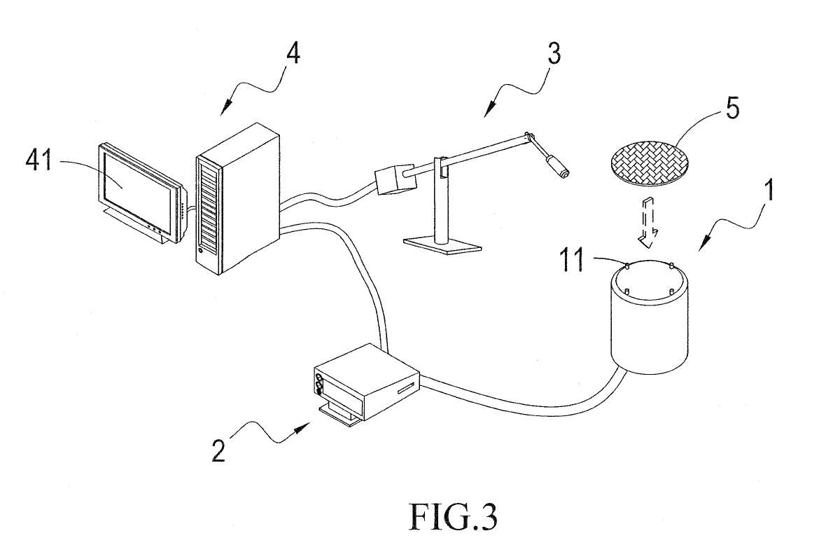

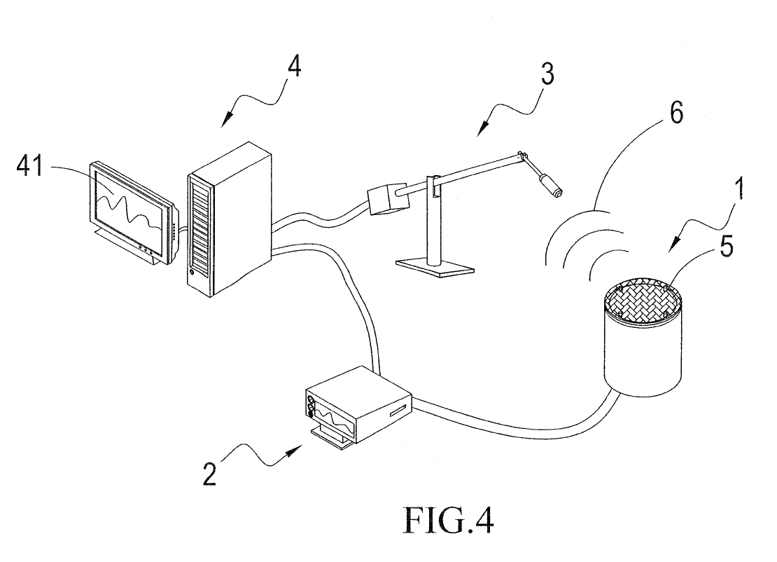

As shown in FIGS. 3 and 4, the operation of the examination system is as follows. A crystalline silicon solar cell 5 is placed on the support element 11 and then the signal generation device 2 is turned on to drive the support element 11 into a high speed vibration. The crystalline silicon solar cell 5 is therefore synchronously vibrated at a high speed and produced a vibrating sound 6. If the crystalline silicon solar cell 5 does not have any surface or internal crack, there is no high-frequency frictional noise from the lattice of the crystalline silicon solar cell 5. Otherwise, a high-frequency frictional noise would be produced among the vibrating sound 6. The sound 6 is collected by the audio collection device 3 and transformed into digital signals for the processing device 4 to analyze. The processing device 4 is able to filter out the high-frequency frictional noise and displays it as a spike on the display 41. If there is no surface or internal crack and therefore no high-frequency friction noise, there will be no spikes on the display 41 and the crystalline silicon solar cell 5 can be identified as one with no cracks.

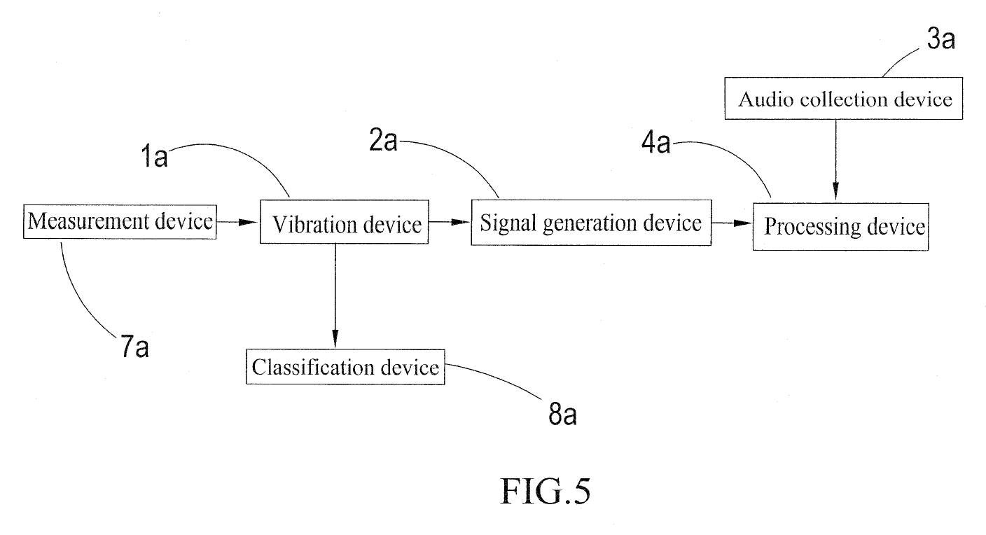

Alternatively, as shown in FIG. 5, another embodiment of the present invention contains a vibration device 1a, a signal generation device 2a, an audio collection device 3a, and a processing device 4a. The signal generation device 2a controls the vibration device la to vibrate and the audio collection device 3 collects the sound produced by the vibrated crystalline silicon solar cell. The sound is processed by the processing device 4a. Additionally, before the crystalline silicon solar cell is placed on the vibration device 1a, its thickness is first measured by a measurement device 7a and the measurement data is passed to the signal generation device 2a. As such, the signal generation device 2a is able to put a thicker crystalline silicon solar cell under a stronger vibration and a thinner crystalline silicon solar cell under a less strong vibration, so that the thinner crystalline silicon solar cell will not be broken by a too strong vibration.

Furthermore, a classification device 8a is integrated so as to place a crystalline silicon solar cell at different places based on the examination result. For example, if the crystalline silicon solar cell is identified to have no cracks, it is placed in a zone A whereas, if it is identified to have cracks, it is placed in a zone B. It is also possible to further differentiate defected crystalline silicon solar cells in accordance with their degrees of cracks. In this way, the examination system is able to achieve a classification function so that the crystalline silicon solar cells delivered are guaranteed to have a specific quality

The present invention has the following advantages. The examination system is applicable to the middle or latter stages of production process where crystalline silicon solar cells with surface or internal cracks can be quickly identified and their degrees of defection. The human involvement in the examination process therefore can be significantly reduced, and the production yield can be greatly enhanced, achieving effective and economic quality control to the production of the crystalline silicon solar cells.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An examination system for a crystalline silicon solar cell, comprising:
a vibration device having at least a support element for the placement of said crystalline silicon solar cell;
a signal generation device controlling said vibration device to vibrate said support element;
at least an audio collection device place adjacent to said vibration device collecting a sound from said crystalline silicon solar cell when said crystalline silicon solar cell is vibrated; and
a processing device connected to said signal generation device and said audio collection device, said processing device processing said sound collected by said audio collection device and producing an analysis result regarding whether said crystalline silicon solar cell has cracks or not.

2. The examination system according to claim 1, wherein said vibration device is one of an electromagnetic vibration device, a mechanical vibration device, a supersonic vibration device, and an air stroke vibration device.

3. The examination system according to claim 1, wherein said signal generation device contains a power amplification element.

4. The examination system according to claim 1, wherein said processing device is a computer.

5. The examination system according to claim 1, wherein said processing device is connected to a display; and said analysis result from said processing device is shown on said display.

6. The examination system according to claim 1, further comprising a measurement device measuring a thickness of said crystalline silicon solar cell and the obtained measurement is delivered to said signal generation device so that an appropriate degree of vibration is determined.

7. The examination system according to claim 1, further comprising a classification device by which said crystalline silicon solar cell is placed at an appropriate place based on said analysis result.

8. The examination system according to claim 1, wherein said audio collection device is a microphone.
